(19) United States
(12) Patent Application Publication
(10) Pub. No.: US 2005/0048439 A1
(43) Pub. Date: Mar. 3, 2005

(54) Case for retaining a toothbrush and other dental cleaning tools therein

(76) Inventor: Patrick Gwen, Houston, TX (US)

Correspondence Address: John S. Egbert;Harrison & Egbert, 7th Floor, 412 Main Street, Houston, TX, 77002, US

(21) Appl. No.: 10/830,145

(22) Filed: Apr. 23, 2004

Related U.S. Application Data
(63) Continuation-in-part of application No. 10/647,128, filed on Aug. 25, 2003.

(51) Int. Cl. A61C 3/00

(52) U.S. Cl. 433/141

(57) ABSTRACT

A dental tool apparatus has a case and a first cleaning tool pivotally mounted in the case so as to be movable between a first position within the case to a second position extending outwardly of the case. The first cleaning tool is a toothbrush that has bristles extending outwardly therefrom transverse to the longitudinal axis of the case when the toothbrush is in the first position. A second cleaning tool and a third cleaning are also pivotally mounted within the case. A closure member is pivotally connected to the case so as to be movable between a covering position and an open position.

### RELATED U.S. APPLICATIONS

The present invention is a continuation-in-part of U.S. application Ser. No. 10/647,128, filed on Aug. 25, 2003, and entitled “Case for Retaining Dental Cleaning Tools Therein” presently pending.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to dental tools. More particularly, the present invention relates to cases that retain the dental tools therein. Additionally, the present invention relates to toothbrushes, toothpicks and interdental brushes that can be pivotally retained within a case for easy transportability and use.

### BACKGROUND OF THE INVENTION

A variety of implements can be used for the cleaning of the mouth. Conventionally, toothbrushes are used for the specific cleaning of the teeth. Toothbrushes are often used in association with toothpaste so as to assure clean teeth and to prevent dental decay. Toothbrushes are usually individually packaged and used as an individual item. During transport, the toothbrushes are often carried separately in a shaving kit, or accessory bag, so as to be available for individual use when desired. In many circumstances, these individual toothbrushes become lost or misplaced during transport. Additionally, the toothbrushes often have an extended length that make them rather inconvenient for pocket transport. Additionally, and furthermore, even if an individual would choose to transport such toothbrushes in his or her pocket, the moisture associated with the bristles would often be transferred onto clothing. As such, a carrying case would also be required

In the past various transportable toothbrushes have been developed. The most common type of transportable toothbrush is a toothbrush which has a handle having a relatively short length. The toothbrush stored within a carrying case. When use of the toothbrush is desired, the toothbrush, along with its handle, is removed from the carrying case and inverted into the carrying case. As a result, the carrying case, attached in friction-fit relationship, will support the handle and the associated bristles in an extended position. After use, the toothbrush is re-inverted and inserted so that the bristles are retained within the interior of the carrying case.

Another type of prior art transportable toothbrush involves the pivotal mounting of the handle across the carrying case. The handle is rotated about an axis so that the bristles can be moved from a position retained within the case to a position extending outwardly of the case. The orientation of the bristles makes it difficult for any other cleaning tools to be incorporated within the carrying case. Additionally, the carrying case lacks sufficient support so as to rigidly and fixedly maintain the handle of the toothbrush in a position during brushing. Many times, the forces applied across the supporting axle of the handle of the toothbrush will cause the axle, along with the carrying case, to be damaged or destroyed.

In other circumstances, various types of toothpicks are often used for the purpose cleaning the interstices between the teeth. It has been known that it is important to prevent gum disease affects the integrity of the teeth. As such, various types of toothpicks and dental floss have been developed so as to clean these interstices between the teeth. Food particles can be removed which would otherwise be inaccessible by the toothbrushes. Toothpicks, have a wide variety of configurations and shapes. Some toothpicks are designed to be directly introduced into the spaces between the teeth. Other toothpicks are designed so as to dig into the gums adjacent the roots of the teeth.

Interdental brushes are commonly used so as to clean the spaces between the teeth. Conventionally, interdental brushes are prepared by mounting bristles extending transversely to wrapped wire. As such, the bristles are in a position so as to be directly inserted into the spaces between the teeth. In common use, the wrapped wire is applied to the end of a long handle so that the interdental bristles can be properly inserted into the desired area of the spaces between the teeth.

To carry out a full and effective cleaning of the teeth, it is proper to brush the teeth, to use toothpicks on the gums and the spaces between the teeth, and to insert interdental bristles between the teeth for further cleaning. Unfortunately, each of these items must be carried separately by the individual during transit. As a result, the toothbrush, the toothpick, or the interdental brush can become lost or damaged. The inconvenience of carrying all of these separate items often works against the proper and desired cleaning of the teeth. It would be desirable to include various tools within a single container or case so that proper dental hygiene can be promoted.

It is an object of the present invention to provide a dental tool apparatus which allows a variety of dental tools to be conveniently carried within a carrying case.

It is another object of the present invention to provide a dental tool apparatus which retains toothbrushes, toothpicks and interdental bristles therein.

It is a further object of the present invention to provide a dental tool apparatus which allows the dental tools to be moved between a stowed position to a portion ready for use.

It is a further object of the present invention to provide a dental tool apparatus which provides for the proper positioning of a toothbrush within a carrying case so that toothpicks and interdental brushes can be retained within the case.

It is a further object of the present invention to provide a dental tool apparatus whereby the toothbrush is adequately supported in a rigid and fixed position during use and which avoids the application of unnecessary and undesired pressures to the pivotal supporting axle for the toothbrush.

It is still a further object of the present invention to provide a dental tool apparatus which easy to use and relatively inexpensive.

These and other objects and advantages of the present invention will become apparent from a reading of the attached specification and appended claims.

### BRIEF SUMMARY OF THE INVENTION

The present invention is a dental tool apparatus that has a case with a longitudinal axis and a first cleaning tool pivotally mounted within the case. The first cleaning tool is pivotally mounted within the case so as to be movable between a first position within the case to a second position extending outwardly of the case. The first cleaning tool is a toothbrush. The toothbrush has bristles extending outwardly therefrom in an orientation transverse to the longitudinal axis of the case when the toothbrush is in the first position.

The dental tool apparatus of the present invention further includes a second cleaning tool that is pivotally mounted in the case so as to be movable between a first position within the case to a second position extending outwardly of the case. The apparatus of the present invention further includes a third cleaning tool which is pivotally mounted in the case so as to be movable between a first position within the case to a second position extending outwardly of the case. The toothbrush, the second cleaning tool and the third cleaning tool are each pivotable adjacent an end of the case about an axis extending transverse to the longitudinal axis of the case. A closure member is pivotally connected to an opposite end of the case. This closure member is movable between a covering position covering the cleaning tools within the case and an open position allowing the cleaning tools to move from the first position to the second position. The closure member retains at least one of the cleaning tools in the second position when the closure member is in the covering position. The closure member is pivotable about an axis which extends transverse to the longitudinal axis of the case.

In the present invention, the toothbrush has flap extending outwardly of a surface thereof. The closure member has a surface that abuts this flap when the closure member is in covering position. The toothbrush also has a lever member extending outwardly of the case when the first cleaning tool is in the first position. The second cleaning tool also has a lever member extending outwardly of the end of the case when the second cleaning tool is in the first position. The lever member of the toothbrush is angularly offset from the lever member of the second cleaning tool. The case has an abutment member extending thereacross. The lever member of the toothbrush contacts the abutment member when in the second position. The toothbrush also has a notch formed on the surface thereof. A surface of the closure member is received within the notch when the closure member is in the covering position.

In the preferred embodiment of the present invention, the second cleaning tool is a toothpick and the third cleaning tool is an interdental brush. The toothpick and the interdental brush each have a length less than a length extending from the pivotal mounting of the toothbrush and the bristles thereof. In other words, a space is defined within the area between the bristles and the pivotal mounting of the toothbrush. The toothpick and the interdental brush are received within this space when positioned in the stowed position. The first and second cleaning tools are pivotally mounted coaxially about an axle extending transversely across the case.

### BRIEF DESCRIPTION OF THE SEVERAL VIEWS OF THE DRAWINGS

FIG. 1 is a perspective view of the dental tool apparatus of the present invention.

FIG. 2 is a side elevational view of the dental tool apparatus of the present invention with the dental cleaning tools in their stowed position.

FIG. 3 is a plan and transparent view showing the stowage of the dental cleaning tools within the interior of the case of the present invention.

FIG. 4 is a side elevational view showing the deployment of the toothbrush of the dental tool apparatus of the present invention.

FIG. 5 is a side elevational view showing the deployment of the interdental brush of the present invention.

FIG. 6 is a side elevational view showing the deployment of the toothpick of the dental tool apparatus of the present invention.

### DETAILED DESCRIPTION OF THE INVENTION

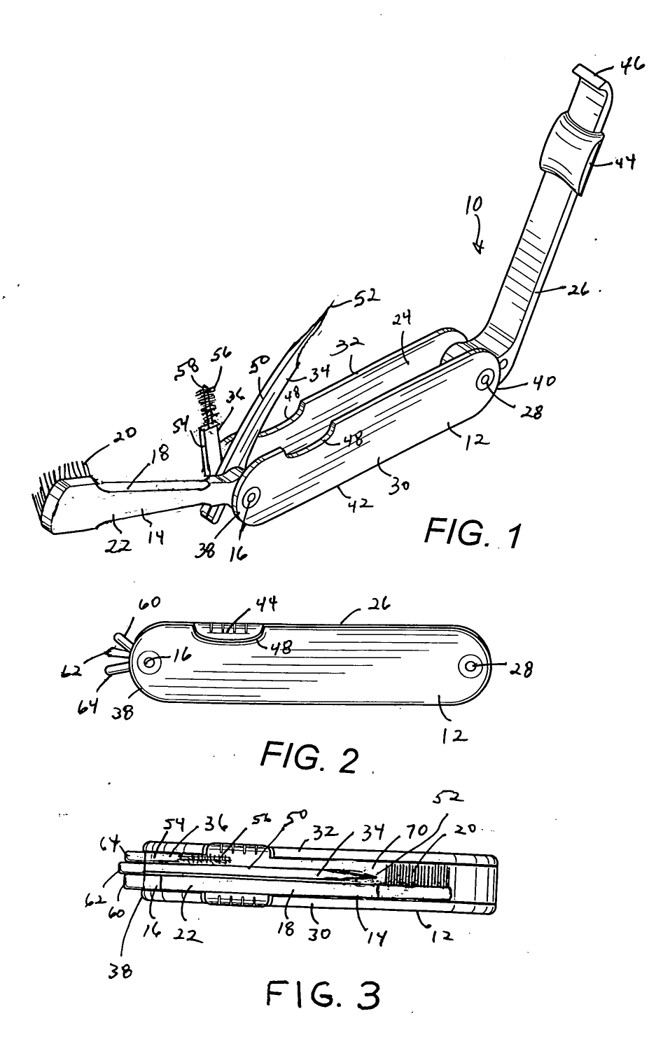

Referring to FIG. 1, there is shown the dental tool apparatus 10 in accordance with the preferred embodiment of het present invention. The dental tool apparatus 10 includes a case 12 and a first cleaning tool 14 pivotally mounted about axis 16 extending transversely across the case 12. The first cleaning tool 14 is a toothbrush 18 having bristles 20 at an end thereof opposite the pivotal connection 16. The bristles 20 are illustrated as extending outwardly from the handle 22 of the toothbrush 18 in an orientation transverse to the longitudinal axis of the case 12. The bristles 20 will also have a length which is less than the width of the opening 24 of the case 12. A closure member 26 has a pivotal connection 28 at an end of the case 12 opposite the pivotal connection 16. The closure member 26 is illustrated in FIG. 1 in its open position. The closure member 26, as will be described hereinafter, can pivot about the pivotal connection so as to lower into a closed position.

The case 12 has a first side 30 and a second side 32 which define the opening 24 therebetween. The distance between the sides 30 and 32 should be sufficient so as to allow the first cleaning tool 14, a second cleaning tool 34 and a third cleaning tool 36 to be retained therein. As will be described hereinafter, the distance between the bristles 20 of the toothbrush 18 and the pivotal connection 16 will define a space within the interior of the case 12 into which the toothpick 34 and the interdental brush 36 can be retained. The toothpick 34 and the interdental brush 36 are each coaxially pivotally mounted about pivotal connection 16 adjacent an end 38 of the case 12. The pivotal connection 28 is adjacent to the opposite end 40 of the case 12. The backside 42 of the case 12 will be suitably closed across the space between the sides 30 and 32.

The closure member 26 is an elongated length of a plastic material having a snap-fit section 44 formed therealong and a surface 46 at an end opposite the pivotal connection 28. As will be described hereinafter, the surface 46 will be suitable for engaging a notch formed on each of the dental tools 14, 34 and 36 so as to retain the dental tools 14, 34 and 36 in an outwardly extending position. The snap-fit section 44 will be suitable for fitting within retaining grooves 48 formed, respectively, on the upper edges of sides 30 and 32. The closure member 26 is movable between the open position, as illustrated in FIG. 1, to a closed position, as illustrated in FIG. 2. In the closed position, the snap-fit section 44 will be retained within the retaining grooves 48 so as to cover the opening 24 between the sides 30 and 32 of the case 12.

In FIG. 1, it can be seen that the first cleaning tool 14 is a toothbrush 18. The toothbrush has one end that is pivotally connected to the pivotal connection 16. The pivotal connection 16 is in the form of an axle extending between the sides 30 and 32 of the case 12. Handle 22 extends outwardly from the pivotal connection 16 so as to support the bristles 20 therefrom. The bristles 20 face from the surface of the handle 22 toward the side 32 of case 12. The toothbrush 18, along with the bristles 20, can be formed through an injection molding process.

The second cleaning tool 34 is in the form of an elongated toothpick. This elongated toothpick 34 has a shank 50 extending from the pivotal connection 16 toward the pointed end 52. The interdental brush 36 also has a shank 54 extending from the pivotal connection 16. A plurality of interdental bristles 56 extend outwardly from a supporting rod 58 extending outwardly from the shank 54. Ideally, the bristles 56 will extend outwardly in general alignment with the rectangular cross section of the shank 54. Because of the nature of interdental brush 36, it is only necessary that the bristles 56 extend in one direction.

FIG. 2 illustrates the closure member 26 in its covering position over the case 12. As can be seen, the closure member 26 has been rotated about the pivotal connection 28 such that the snap-fit section 44 is retained within the retaining grooves 48. As can be seen, a first lever member 60 extends outwardly from the end 38 of case 12. Another lever 62 extends outwardly from the end 38 of case 12. Finally, a third lever member 64 extends outwardly from the end 38 of the case 12. The first lever member 60 is associated with the first cleaning tool 14. The second lever member 62 is associated with the second cleaning tool 34. Finally, the third lever member 64 is associated with the third cleaning tool 36. Each of the lever members 60, 62 and 64 is angularly offset from one another so that the individual cleaning tools can be properly selected and rotated outwardly of the interior of the case 12.

As can be seen in FIG. 2, each of the cleaning tools 14, 34 and 36 is conveniently, safely, and hygienically, retained within the interior of the case 12. The closure member 26 snap fits into position over each of the cleaning tools 14, 34 and 36 so as to prevent contamination from entering the interior of the case 12. When it is desired to access the cleaning tools 14, 34 and 36, it is only necessary to pull up on the snap-fit section 44 so as to release the snap-fit section 44 from its position over the opening 24 of the case 12. The desired cleaning tool can then be rotated from the stowed position to the deployed position by selecting one of the lever members 60, 62 and 64 so as to rotate the particular cleaning tool about the pivotal connection into a deployed position.

FIG. 3 illustrates each of the cleaning tools 14, 34 and 36 as in the stowed position between the sides 30 and 32 of case 12. In particular, it can be seen that the toothbrush 18 is stowed so as to have the handle 22 positioned adjacent to the side 30. The bristles 20 are illustrated as extending outwardly from the end of handle 22 opposite the pivotal connection. The bristles 20 are also illustrated as extending transversely to the longitudinal axis of the case 12. The space 70 between the bristles 20 and the pivotal connection 16 is an area by which the second cleaning 34 and the third cleaning tool 36 can be stowed. As such, the particular design of the present invention facilitates the ability to install other cleaning tools within the interior of case 12.

In FIG. 3, it can be seen that the second cleaning tool 34 has shank 50 positioned in generally side-by-side relationship to the handle 22 of the toothbrush 18. The pointed end 52 of the second cleaning tool 34 is positioned within the space 70 generally inwardly of the bristles 20. The third cleaning tool 36 is illustrated as having shank 54 positioned adjacent to the shank 50 of the second cleaning tool 34. The bristles 56 are illustrated as also positioned adjacent to the shank 50 of the second cleaning tool 34. The third cleaning tool 36 will be positioned generally adjacent to the inner wall of side 32 of the case 12. The levers 60, 62 and 64 are illustrated as extending outwardly of the end 38 of the case 12. As such, each of the cleaning tools 14, 34 and 36 can be selectively rotated about the pivotal connection 16 so as to move from the stowed position (as illustrated in FIG. 3) to an outwardly extending position.

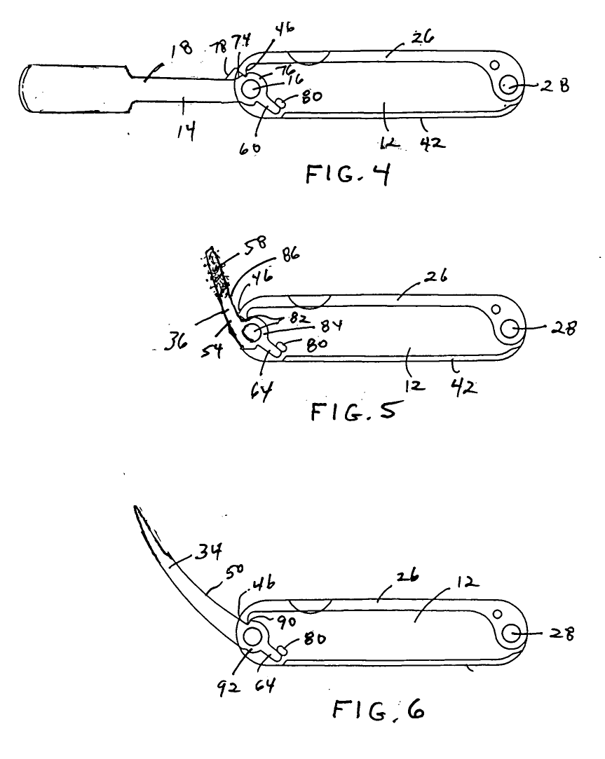

FIG. 4 shows the toothbrush 18 in its outwardly deployed position. Importantly, the mechanisms of the present invention serve to support the toothbrush 18 in its outwardly deployed position. Additionally, the structures of the present invention serve to prevent the forces that are applied to the toothbrush during brushing from destroying the case 12 or the pivotal connection 16 between the toothbrush 18 and the case 12. In particular, in FIG. 4, the closure member 26 is illustrated in its covering position. The closure member 26 has surface 46 engaged within a notch 74 formed on the axle engaging surface 76 of toothbrush 18. A flap 78 is in abutment with the surface 46 of closure member 26. The lever member 60 of the toothbrush 18 is in surface-to-surface contact with an abutment member 80 extending between the sides 30 and 32 of the case 12. As a result of this orientation, the toothbrush 18 will be fixedly and securely retained in an outwardly extending position. The various mechanisms serve to distribute the forces appropriately so as to avoid damage to the case 12 or the pivotal connection 16 during brushing activities. The torque forces that are applied to the toothbrush 18 during brushing activities will be distributed to the surfaces between the flap 60 and the abutment member 80, between the notch 74 and the surface 46, and between the surface 46 and the flap 78.

FIG. 5 shows the third cleaning tool 36 in its outwardly deployed position. In particular, the closure member 26 is rotated about its pivotal connection 28 so as to be in its covering position. The surface 46 is illustrated as engaged with a notch 82 formed on the bearing surface 84 of the third cleaning tool 36. The lever member 64 is illustrated as in surface-to-surface contact with the abutment member 80. The forces associated with the use of the bristles 56 of the interdental brush 36 will be distributed between the surface 46 and the notch 82, between the inner surface 86 of the shank 54 and the surface 46, and between the lever member 64 and the abutment member 80.

FIG. 6 illustrates the second cleaning tool 34 extending in its deployed position outwardly of the case 12. Once again, the closure member 26 is illustrated in its covering position and is rotated about the pivotal connection 28. The surface 46 is engaged with a notch 90 formed on the bearing surface 92 of the toothpick 34. The lever member 64 is illustrated as in abutment with the abutment surface 80. The shank 50 of the toothpick 34 has a surface in surface-to-surface contact with the surface 46 of closure member 26. As such, any forces applied to the toothpick 34 will be distributed over a variety of surfaces, similar to that described in association with the first cleaning tool 14 and the third cleaning tool 36.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

1. A dental tool apparatus comprising:
a case having a longitudinal axis;
a first cleaning tool pivotally mounted in said case so as to be movable between a first position within said case to a second position extending outwardly of said case, said first cleaning tool being a toothbrush, said toothbrush having bristles extending outwardly therefrom in an orientation transverse to said longitudinal axis when said toothbrush is in said first position.

2. The dental tool apparatus of claim 1, further comprising:
a second cleaning tool pivotally mounted in said case so as to be movable between a first position within said case to a second position extending outwardly of said case.

3. The apparatus of claim 2, further comprising:
a third cleaning tool pivotally mounted in said case so as to be movable between a first position within said case to a second position extending outwardly of said case.

4. The apparatus of claim 1, said toothbrush being pivotable adjacent an end of said case about an axis extending transverse to said longitudinal axis of said case.

5. The apparatus of claim 4, further comprising:
a closure member pivotally connected to said case, said closure member movable between a covering position covering said first cleaning tool within said case and an open position allowing said first cleaning tool to move from said first position to said second position.

6. The apparatus of claim 5, said closure member retaining said first cleaning tool in said second position when said closure member is in said covering position.

7. The apparatus of claim 5, said closure member pivotable adjacent an opposite end of said case about an axis extending transverse to said longitudinal axis of said case.

8. The apparatus of claim 5, said first cleaning tool having a flap extending outwardly of a surface thereof, said closure member having a surface abutting said flap when said closure member is in said covering position.

9. The apparatus of claim 2, said first cleaning tool having a lever member extending outwardly of said case when said first cleaning tool is in said first position, said second cleaning tool having a lever member extending outwardly of an end of said case when said second cleaning tool is in said first position.

10. The apparatus of claim 9, said lever member of said first cleaning tool being angularly offset from said lever member of said second cleaning tool.

11. The apparatus of claim 9, said case having an abutment member extending thereacross, said lever member of said first cleaning tool contacting said abutment member when in said second position.

12. The apparatus of claim 8, said first cleaning tool having a notch formed on a surface thereof, said surface of said closure member received within said notch when said closure member is in said covering position.

13. The apparatus of claim 3, said second cleaning tool being a toothpick, said third cleaning tool being an interdental brush.

14. The apparatus of claim 13, said toothpick and said interdental brush each having a length less than length extending from the pivotal mounting of said toothbrush to the bristles.

15. The apparatus of claim 2, said case having an axle extending thereacross, said first and second cleaning tools being pivotally mounted coaxially on said axle.

16. A dental tool apparatus comprising:
a case having a longitudinal axis;
a toothbrush pivotally mounted adjacent one end of said case so as to be movable between a first position within said case to a second position extending outwardly of said case, said toothbrush having a axis of rotation extending transverse to said longitudinal axis of said case; and
a closure member pivotally connected adjacent an opposite end of said case, said closure member movable between a covering position covering said toothbrush within said case and an open position allowing toothbrush to move from said first position to said second position.

17. The apparatus of claim 16, said toothbrush having bristles at an end thereof, said bristles extending outwardly of said end of said toothbrush generally transverse to said longitudinal axis of said case, said bristles and said one end of said case defining a space within said case.

18. The apparatus of claim 17, further comprising:
a cleaning tool pivotally mounted coaxially with said toothbrush in said case, said cleaning tool movable between a first position within said case and a second position extending outwardly of said case, said cleaning tool residing in said space when in said first position.

19. A dental tool apparatus comprising:
a case having a longitudinal axis;
a toothbrush pivotally mounted about an axis transverse to said longitudinal axis of said case so as to be movable between a first position within said case to a second position extending outwardly of said case; and
a closure member pivotally connected to said case, said closure member movable between a covering position covering said toothbrush within said case and an open position allowing toothbrush to move from said first position to said second position.

20. The apparatus of claim 19, said closure member retaining said toothbrush in said second position when said closure member is in covering position, said toothbrush having a flap extending outwardly of a surface, said closure member having a surface abutting said flap when said closure member is in said covering position, said toothbrush having a notch formed on another surface thereof, said surface of said closure member received within said notch when said closure member is in said covering position.
